(19) United States
(12) Patent Application Publication
(10) Pub. No.: US 2025/0302034 A1
(43) Pub. Date: Oct. 2, 2025

(54) LOW DRIFT TANK MIX ADDITIVE FOR LOW, MEDIUM, AND HIGH SPRAY VOLUME APPLICATION

(71) Applicant: BAYER AKTIENGESELLSCHAFT, LEVERKUSEN (DE)

(72) Inventor: Malcom Andrew FAERS, Dusseldorf (DE)

(21) Appl. No.: 18/863,767

(22) PCT Filed: May 4, 2023
(86) PCT No.: PCT/EP2023/061763

§ 371 Date: Nov. 7, 2024

(30) Foreign Application Priority Data
May 7, 2022 (EP) 22172207.7

(51) Int. Cl. A01N 25/06; A01N 25/24

(52) U.S. Cl. CPC A01N 25/06; A01N 25/24

(57) ABSTRACT

The instant invention is directed to tank mix additive for low, medium, and high spray volume application, which contain a combination of different drift reducing agents.

The instant invention is directed to tank mix additive for low, medium, and high spray volume application, which contain a combination of different drift reducing agents.

Low and medium volume spray applications are becoming more and more popular, since they require less water, lighter vehicles, and in some cases, less adjuvants to be brought into the environment.

However, formulations currently in the market are often available only for high or medium spray volumes, or low and medium spray volumes, but never cover all ranges. For the farmer it is nevertheless desired and economically feasible, if one formulation could be used for all types of application depending on the application method, requirements, environmental conditions etc.

On the other hand, it is of economic advantage for the supplier to provide only one formulation for all ranges.

Tank mix additives are important additives for enhancing the performance of crop protection products, especially when they contain components that enhance wetting, spreading and uptake on the target crop and plants. However, these wetting, spreading and uptake enhancing components can enhance drift by reducing the droplet size in the spray after atomization, especially when these components are surfactants.

To address this drift risk drift reducing agents can be included in the tank mix adjuvant recipe.

It is known in the art that different drift reducing additives work better at different spray volumes owing to their different concentrations in the spray liquid after dilution.

Polymer-based drift reducing additives work best at higher concentrations where their viscosity increasing effect is stronger. Drift reducing polymers increase the viscosity of tank mix compositions and there is a viscosity upper limit beyond which the tank mix formulation is too thick to use. A consequence of this is that in a 0.5 to 0.25 l/ha formulation it is difficult to include sufficient polymer to reduce drift when sprayed at high spray volumes since the high amount of polymer makes the tank mix formulation too viscous to use. However, this is not the case at low spray volumes where much lower amounts of polymer are required in the formulation to give an effective concentration in the spray liquid. Conversely, a tank mix formulation containing sufficient polymer to reduce drift at high spray volumes will be unsprayable at low spray volumes where the high polymer concentration will inhibit the atomization process, making the spray liquid unsprayable.

Oil-based drift reducing additives work well over a wide range of concentrations. However, their effect can be reduced by surfactants in the spray liquid after dilution either as dispersants, emulsifiers, wetters, spreading agents or uptake enhancing agents either from products used in the spray dilution or from components in the tank mix adjuvant with the consequence that oil-based drift reducing additives can lose their effect at lower spray volumes where the concentration of these surfactants in the spray liquid is higher.

There is therefore a need for drift reducing tank mix additives that can work at both low and high spray volumes. This is achieved by the invention here where both polymer-based drift reducing additives and oil-based drift reducing additives are combined in effective levels in tank mix formulations.

Surprisingly, it has been found that tank mix additives comprising a combination of certain polymers with oil-based drift reducing additives in quite low concentrations can provide a drift reduction in said tank mix over a wide range of spray volumes.

The combination of hydroxypropylated guar or other guar gums with oils in drift reducing compositions is already disclosed in US2002/108415 A1, WO2022/023255 A1, WO2021/127865 A1 and US2018/184647 A1. However, the oil component is always used in very high amounts and serves different purposes beside drift-reduction, e.g. as carrier and uptake enhancer.

The respective tank mix additive according to the invention, or to be more precise the combination of certain adjuvants comprised in the additive, are described in the following.

In one aspect, the invention refers to a tank mix additive for an agrochemical formulation comprising:
a) One or more polymer-based drift reducing additive, selected from the group of poly (ethylene-oxide) (PEO in the following) and hydroxypropylated guar (HP guar in the following),
b) one or more oil-based drift reducing additive,
c) one or more spreading agents and/or uptake promoting additive,
d) other formulants,
e) one or more carrier to volume, wherein at least one carrier is water,
   wherein a) is present in 0.2-50 g/l, preferably in 0.5-40 g/l, and more preferably in 1-15 g/l,
   wherein b) is present in 0.5-45 g/l, preferably in 1-30 g/l, and more preferably in 5-25 g/l,
   wherein c) is present in 10-200 g/l, preferably in 20-160 g/1, and more preferably in 25-140 g/l, and
   wherein d) is present in 20-300 g/l, preferably in 30-180 g/l, and more preferably in 30-135 g/l.

In a preferred embodiment,
a) is present in 0.2-50 g/l,
b) is present in 0.5-45 g/l,
c) is present in 10-200 g/l,
d) is present in 20-300 g/l,
e) carrier to volume.

In a further preferred embodiment
a) is present in 0.5-40 g/1,
b) is present in 1-30 g/l,
c) is present in 20-160 g/l,
d) is present in 30-180 g/l,
e) carrier to volume.

In an even further preferred embodiment
a) is present in 1-15 g/l,
b) is present in 5-25 g/l,
c) is present in 25-140 g/l,
d) is present in 30-135 g/l,
e) carrier to volume.

It is understood that in case of combinations of various components, the percentages of all components of the tank mix additive always sum up to 100.

If not otherwise indicated, % in this application means percent by weight (% w/w).

Further, if not otherwise indicated, the reference “to volume” for the carrier indicates that the carrier, especially water, is added to a total volume of the tank mix additive of 1000 ml (11). For the sake of clarity it is understood that if unclear the density of the tank mix additive is understood as to be 1 g/cm3.

If not otherwise defined in this application, the molecular weight refers to the weight-average molecular weight Mw which is determined by GPC in methylene chloride at 25° C. with polystyrene as the standard.

In the context of the instant invention, the tank mix additive can be applied using the wide range of spray volumes from 1 l/ha to 2000 l/ha, preferably 5 l/ha to 1500 l/ha and more preferably from 8 l/ha to 1200 1/ha.

One further aspect of the present invention is therefore a method of applying an agrochemical tank mix additive according to the invention onto crops, wherein the tank mix additive is applied at a spray volume of between 1 l/ha to 2000 l/ha, preferably 5 l/ha to 1500 l/ha and more preferably from 8 l/ha to 1200 1/ha.

Another aspect of the present invention is therefore the use of the tank mix additive according to the invention for applying it onto crops, wherein the tank mix additive is applied at a spray volume of between 1 l/ha to 2000 l/ha, preferably 5 l/ha to 1500 l/ha and more preferably from 8 l/ha to 1200 l/ha.

Moreover, for low spray volumes the tank mix additive according to the instant invention is applied at a spray volume of between 1 and 25 l/ha, preferably 2 and 20 l/ha, and more preferably 5 and 15 l/ha.

One further aspect of the present invention is therefore a method of applying an agrochemical tank mix additive according to the invention onto crops, wherein the tank mix additive is applied at a spray volume of between 1 and 25 l/ha, preferably 2 and 20 l/ha, and more preferably 5 and 15 l/ha.

Another aspect of the present invention is therefore the use of the tank mix additive according to the invention for applying it onto crops, wherein the tank mix additive is applied at a spray volume of between 1 and 25 l/ha, preferably 2 and 20 l/ha, and more preferably 5 and 15 l/ha.

Preferably the tank mix additive is applied at the above-mentioned spray volumes as a spray liquid containing the tank mix additive.

The ratio in the tank mix additive according to the invention of a) to b) is from 1:40 to 10:1, more preferably from 1:10 to 5:1, most preferred 1:6 to 2:1.

The ratio in the tank mix additive according to the invention of a) to b) to c) is from 1:40: 150 to 10:1: 10, more preferably from 1:12: 120 to 2:1: 5, most preferred 1:8: 50 to 1:2: 5.

Preferably the above mentioned ratios are also the same for a spray liquid containing the tank mix additive.

One further aspect of the invention is the use of the tank mix additive according to the invention to deliver to the agricultural target plot:

An amount of a) between 0.5 and 15 g/ha, more preferably between 1 and 12 g/ha, most preferred between 1 and 10 g/ha.

An amount of b) between 0.5 and 40 g/ha, more preferably between 1 and 20 g/ha, most preferred between 2 and 10 g/ha.

An amount of c) between 10 and 200 g/ha, more preferably between 15 and 160 g/ha, most preferred between 20 and 100 g/ha.

In a further preferred embodiment of the present invention the tank mix additive consists only of the above described ingredients a) to d) in the specified amounts and ranges.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In the context of the present invention, suitable agrochemical formulations to which the tank mix additive according to the instant invention is added are amongst others suspension concentrates, aqueous suspensions, suspo-emulsions or capsule suspensions, emulsion concentrates, dispersion concentrates, soluble liquids, water dispersible granules, oil dispersions, emulsifiable concentrates, dispersible concentrates, wettable granules, preferably suspension concentrates, aqueous suspensions, suspo-emulsions and oil dispersions, wherein in the case of non-aqueous formulations or solid formulations the sprayable formulation are obtained by adding water.

Suitable agrochemical formulations to which the tank mix additive according to the instant invention is added are insecticidal, herbicidal, fungicidal, antibacterial, host defence inducer, nutrient formulations or formulations of safeners or biologicals, as well as mixtures thereof and any other suitable products to be delivered to plants by spray application.

Polymer-based drift reducing additive a)

Suitable drift reducing polymers are poly (ethylene oxides), wherein the polymer has an average molecular weight preferably from 0.5 to 14 million g/mol, more preferred from 0.75 to 10 million g/mol, and most preferred from 1 to 8 million g/mol, and hydroxypropyl guar (HP guar).

In one embodiment the polymer-based drift reducing additive is poly (ethylene oxide) (PEO), wherein even further preferred the tank mix additive shows with a PEO a Polymer Concentration Factor (PCF) value between 0.5 and 12, more preferably between 1 and 10, even more preferably between 2 and 9.

The Polymer Concentration Factor (PCF) for the PEO polymer content in the tank mix additive is defined where C is the drift reducing polymer (a) concentration in the tank mix additive (g/1), M is the molar mass of the drift reducing polymer (a) (g/mol/1x10⁶), a has a value of 1.4 and D is the tank mix additive dose rate per ha (l/ha). The PCF value is calculated from the following equation:

$$P C F = C \times {M}^{a} \times D$$

In another embodiment the polymer-based drift reducing additive is HP guar.

Oil-based drift reducing additive b)

Suitable drift reducing oils are vegetable oils and vegetable oil esters and diesters (including esters with glycerine and propylene glycol).

Particularly preferred are methyl, ethyl, isopropyl, isobutyl, butyl, hexyl and ethylhexyl esters.

More preferred the vegetable oils and esters are selected from the group consisting of methyl oleate, methyl palmitate, rape seed oil methyl ester, isopropyl myristate, isopropyl palmitate, ethylhexyl palmitate, ethylhexyl oleate, mixture of ethylhexyl myristate/laurate, ethylhexyl laurate, mixture of ethylhexyl caprylate/caprate, diisopropyl adipate, coconut oil propyleneglycol diester, sunflower oil, rapeseed oil, corn oil, soybean oil, rice bran oil, olive oil, peanut oil, mixed caprylic and capric triglycerides, and mixed decanoyl and octanoyl glycerides.

Especially preferred are rapeseed oil, rapeseed oil methyl ester or sunflower oil.

Also suitable as drift reducing agent are mineral oils.

Spreading agents and uptake promoting additives c):

Some compounds suitable as spreading agents might due to their chemical nature also act as uptake promoting additives and also the other way round. Therefore those compounds are summarized under compound c).

Spreading agents are compounds enhancing the spreading of the tank mix additive or agrochemical formulations containing the tank mix additive on plant parts, especially on leaves.

Suitable spreading agents are selected from the group comprising mono- and diesters of sulfosuccinate metal salts with branched or linear alcohols comprising 1-10 carbon atoms, in particular alkali metal salts, more particular sodium salts, and most particular sodium dioctylsulfosuccinate;

as well as organosilicone alkoxylates such as organomodified polysiloxanes/trisiloxane alkoxylates, preferably polyalkyleneoxide modified heptamethyltrisiloxane, wherein the alkylenoxide is preferably selected from ethylenoxide (EO) or propylenoxide (PO), in particular from those with the following CAS No. 27306-78-1 (Poly (oxy-1,2-ethanediyl),.alpha.-methyl-. omega.-[3-[1,3,3,3-tetramethyl-1-[(trimethylsilyl)oxy] disiloxanyl] propoxy]), 67674-67-3 (Poly (oxy-1,2-ethanediyl),.alpha.-[3-[1,3,3,3-tetramethyl-1- [(trimethylsilyl) oxy] disiloxanyl] propyl]- omega.-hydroxy), 134180-76-0 (Oxirane, methyl-, polymer with oxirane, mono3-1,3,3,3-tetramethyl-1-(trimethylsilyl)oxydisiloxanylpropyl ether), e.g., Silwet® L77, Silwet® 408, Silwet® 806, BreakThru® S240, BreakThru® S278.

Other suitable spreading agents are ethoxylated diacetylene-diols with 1 to 6 ethylenoxide (EO) units, e.g. Surfynol® 420 and 440;

as well as alcohol alkoxylates, preferably selected from the group comprising ethoxylated alcohols or propoxy-ethoxylated alcohols, more preferably comprising 6-22 carbon atoms and an average of 5-40 ethylenoxide (EO) and/or propylenoxide (PO) units, in particular Genapol® EP 0244, Genapol® EP 2584 or Synergen® W06 or 1-hexanol, 3,5,5-trimethyl-, ethoxylated, propoxylated (CAS-No 204336-40-3), e.g. Break-Thru® Vibrant;

and further alkylpolysaccharides, e.g. Agnique® PG8107, PG8105 of BASF; Atplus® 438, AL-2559, AL-2575 of Croda.

The term “alcohols” within this context refers to alcohols that can be branched or linear, saturated or unsaturated, with 6-22 carbon atoms and optionally carry additional substituents, such as OH groups.

Preferably the spreading agent is selected from the group comprising mono- and diesters of sulfosuccinate metal salts with branched or linear alcohols comprising 1-10 carbon atoms, organomodified polysiloxanes/trisiloxane alkoxylates, ethoxylated diacetylene-diols with 1 to 6 ethylenoxide (EO) units, alcohol alkoxylates comprising 6-22 carbon atoms or alkylpolysaccharides; more sodium dioctylsulfosuccinate, polyalky leneoxide modified preferably from heptamethyltrisiloxanes, ethoxylated diacetylene-diols with 1 to 6 EO units or ethoxylated alcohols or propoxy-ethoxylated alcohols, with 6-22 carbon atoms and an average of 5-40 ethylenoxide (EO) and/or propylenoxide (PO) units;

and in particular from the group comprising sodium dioctylsulfosuccinate, polyalkyleneoxide modified heptamethyltrisiloxane and ethoxylated diacetylene-diols with 1 to 6 ethylene oxide units.

In one further preferred embodiment of the invention the spreading agent c) is selected from the group comprising polyalkyleneoxide modified heptamethyltrisiloxanes, dioctylsulfosuccinate, alcohol ethoxylates and ethoxylated diacetylene-diols with 1 to 6 EO, more preferably from the group comprising polyalkyleneoxide modified heptamethyltrisiloxanes, dioctylsulfosuccinate and ethoxylated diacetylene-diols with 1 to 6 EO.

Uptake promoting additives are compounds enhancing the uptake of the tank mix additive or agrochemical formulations containing the tank mix additive into plants or plant parts, especially into leaves.

Suitable uptake promoting additives are alcohol alkoxylates, preferably selected from the group comprising ethoxylated alcohols or propoxy-ethoxylated alcohols, more preferably comprising 6-22 carbon atoms and an average of 5-40 ethylenoxide (EO) and/or propylenoxide (PO) units;

ethoxylated carboxylic acids or propoxy-ethoxylated carboxylic acids, preferably comprising 6-22 carbon atoms and an average of 5-40 ethylenoxide (EO) and/or propylenoxide (PO) units;

or ethoxylated mono-, di- or triesters of glycerine comprising fatty acids with 8-18 carbon atoms and an average of 5-60, preferably 5-40 EO units.

Said ethoxylated or propoxy-ethoxylated alcohols or carboxylic acids are optionally further modified by addition of a methyl radical to the remaining alcohol functionality (cf. “Me end-capped”).

Further suitable uptake promoting additives are selected from alkoxylated sorbitan fatty acid esters comprising fatty acids with 8-18 carbon atoms and an average of 10-50 ethylene oxide and propylene oxide units;

or ethoxylated coconut alcohols comprising 2-20 EO units;

or castor oil ethoxylates comprising an average of 5-40 EO units.

The term “alcohols” within this context refers to alcohols that can be branched or linear, saturated or unsaturated, with 6-22 carbon atoms and optionally carry additional substituents, such as OH groups. The term “carboxylic acids” within this context refers to carboxylic acids that can be branched or linear, saturated or unsaturated, with 6-22 carbon atoms and optionally carry additional substituents, such as OH groups.

Preferably the uptake promoting additive c) is selected from the group comprising alcohol alkoxylates comprising 6-22 carbon atoms, ethoxylated carboxylic acids or propoxy-ethoxylated carboxylic acids comprising 6-22 carbon atoms, ethoxylated mono-, di- or triesters of glycerine comprising fatty acids with 8-18 carbon atoms and an average of 5-60 EO units, alkoxylated sorbitan fatty acid esters comprising fatty acids with 8-18 carbon atoms and an average of 10-50 ethylene oxide and propylene oxide units, ethoxylated coconut alcohols comprising 2-20 EO units or castor oil ethoxylates comprising an average of 5-40 EO units;
more preferably from ethoxylated alcohols or propoxy-ethoxylated alcohols comprising 6-22 carbon atoms and an average of 5-40 ethylenoxide (EO) and/or propylenoxide (PO) units, ethoxylated carboxylic acids or propoxy-ethoxylated carboxylic acids comprising 6-22 carbon atoms and an average of 5-40 ethylenoxide (EO) and/or propylenoxide (PO) units, ethoxylated mono-, di- or triesters of glycerine comprising fatty acids with 8-18 carbon atoms and an average of 5-60 EO units or alkoxylated sorbitan fatty acid esters comprising fatty acids with 8-18 carbon atoms and an average of 10-50 ethylene oxide and propylene oxide units, ethoxylated coconut alcohols comprising 2-20 EO units or castor oil ethoxylates comprising an average of 5-40 EO units;
and in particular from the group of ethoxylated alcohols or propoxy-ethoxylated alcohols comprising 6-22 carbon atoms and an average of 5-40 ethylenoxide (EO) and/or propylenoxide (PO) units, ethoxylated carboxylic acids or propoxy-ethoxylated carboxylic acids comprising 6-22 carbon atoms and an average of 5-40 ethylenoxide (EO) and/or propylenoxide (PO) units, ethoxylated mono-, di-or triesters of glycerine comprising fatty acids with 8-18 carbon atoms and an average of 5-60 ethyleneoxide units, alkoxylated sorbitan fatty acid esters comprising fatty acids with 8-18 carbon atoms and an average of 10-50 ethylene oxide and propylene oxide units.

In one further preferred embodiment of the invention the uptake enhancer c) is selected from the group comprising ethoxylated alcohols, propoxy-ethoxy lated alcohols, ethoxy lated carboxylic acids, propoxy-ethoxylated carboxylic acids, or ethoxylated mono-, di- or triesters of glycerine comprising fatty acids with 8-18 carbon atoms and an average of 5-40 EO units, alkoxylated sorbitan fatty acid esters comprising fatty acids with 8-18 carbon atoms and an average of 10-50 EO and PO units.

Suitable components c) by way of example are:
ethoxylated linear and/or branched fatty alcohols (e.g. Genapol® X-type of Clariant) with 2-20 EO units;
methyl end-capped, ethoxylated linear and/or branched fatty alcohols (e.g. Genapol® XM-type of Clariant) comprising 2-20 EO units;
ethoxylated coconut alcohols (e.g. Genapol® C-types of Clariant) comprising 2-20 EO units;
ethoxylated C12/15 alcohols (e.g. Synperonic® A-types of Croda) comprising 2-20 EO units;
propoxy-ethoxylated alcohols, branched or linear, e.g. Antarox® B/848 of Solvay, Atlas® G5000 of Croda, Lucramul® HOT 5902 of Levaco;
propoxy-ethoxylated fatty acids, Me end-capped, e.g. Leofat® OC0503M of Lion;
alkyl ether citrate surfactants (e.g. Adsee CE range, Akzo Nobel);
alkylpolysaccharides (e.g. Agnique® PG8107, PG8105 of BASF; Atplus® 438, AL-2559, AL-2575 of Croda);
ethoxylated mono- or diesters of glycerine comprising fatty acids with 8-18 carbon atoms and an average of 10-60, preferably 10-40 EO units (e.g. Crovol® product range of Croda);
castor oil ethoxylates comprising an average of 5-40 EO units (e.g. Berol® range of Nouryon, Emulsogen® EL range of Clariant);
ethoxylated oleic acid (e.g. Alkamuls® A and AP) comprising 2-20 EO units;
alkoxylated sorbitan fatty acid esters comprising fatty acids with 8-18 carbon atoms and an average of 10-50 EO and/or PO units (e.g. Arlatone® T, Tween range).

Other formulants d):

Other formulants d) in the context of the present invention are further additives that are usually used in agrochemical formulations, which are not already covered by components a) to c).

Preferably the other formulants are one or more substances selected from rain-fast additives, surfactants, rheological modifiers, antifoam substances, antifreeze agents, preservatives, biocides, colourants, pH adjusters, buffers, stabilisers, antioxidants, inert filling materials, humectants, crystal growth inhibitors or micronutirients.

d1) Rain-fast additives

Suitable rain-fast additives are acrylic based emulsion polymers or polymer dispersions and styrene based emulsion polymers or polymer dispersions d) are aqueous polymer dispersions with a Tg in the range from −100° C. to 30° C., preferably between −60° C. and 20° C., more preferably between −50° C. and 10° C., most preferably between −45° C. and 5° C., for example Acronal V215, Acronal 3612, Licomer ADH 205 and Atplus FA. Particularly preferred are Licomer ADH205, and Atplus FA.

Preferably, the polymer is selected from the group consisting of acrylic polymers, styrene polymers, vinyl polymers and derivatives thereof, polyolefins, polyurethanes and natural polymers and derivatives thereof.

More preferably, the polymer is selected from the group consisting of acrylic polymers, styrene butadiene copolymers, styrene-maleic anhydride copolymers, polyvinyl alcohol, polyvinyl acetate, partially hydrolysed polyvinyl acetate, methyl vinyl ether-maleic anhydride copolymers, carboxy-modified polyvinyl alcohol, acetoacetyl-modified polyvinyl alcohol, diacetone-modified polyvinyl alcohol and silicon-modified polyvinyl alcohol, isopropylene-maleic anhydride copolymer, polyurethane, cellulose, gelatine, caesin, oxidised starch, starch-vinyl acetate graft copolymers, hydroxyethyl cellulose, methyl cellulose, ethyl cellulose, carboxymethyl cellulose and acetyl cellulose.

Most preferably the polymer is selected from copolymers of an acrylate and a styrene, wherein. Said acrylate selected from the list comprising 2-ethyl-hexyl acrylate, butyl acrylate, sec-butyl acrylate, ethyl acrylate, methyl acrylate, acrylic acid, acrylamide, iso-butyl acrylate, methyl methacrylate, or combinations thereof. Said styrene selected from the list comprising styrene, tert-butyl styrene, para-methyl styrene, or combinations thereof.

In a preferred embodiment the polymer, as described above, has a molecular weight of no more than 40000 g/mol, preferably no more than 10000 g/mol.

In a preferred embodiment the polymer d is an emulsion polymer as described in WO 2017/202684.

The glass transition temperature (Tg) is known for many polymers and is determined in the present invention, if not defined otherwise, according to ASTM E1356-08 (2014) “Standard Test Method for Assignment of the Glass Transition Temperatures by Differential Scanning calorimetry” wherein the sample is dried prior to DSC at 110° C. for one hour to eliminate effect of water and/or solvent, DSC sample size of 10-15 mg, measured from −100° C. to 100° C. at 20° C./min under N₂, with Tg defined as midpoint of the transition region.

d2) Surfactants:
Suitable non-ionic surfactants or dispersing aids are all substances of this type which can customarily be employed in agrochemical agents. Preferably, polyethylene oxide-polypropylene oxide block copolymers, preferably having a molecular weight of more than 5,000 g/mol or a polyethylene oxide content of more than 35%, more preferably having a molecular weight of more than 6,000 g/mol and a polyethylene oxide content of more than 45%, polyoxyalkylenamine derivatives, polyvinylpyrrolidone, copolymers of polyvinyl alcohol and polyvinylpyrrolidone, and copolymers of (meth)acrylic acid and (meth) acrylic acid esters. Out of the examples mentioned above selected classes can be optionally phosphated, sulphonated or sulphated and neutralized with bases.

Possible anionic surfactants are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid.

d3) Rheological modifiers:

A rheological modifier is an additive that when added to the recipe at a concentration that reduces the gravitational separation of the dispersed active ingredient during storage results in a substantial increase in the viscosity at low shear rates. Low shear rates are defined as 0.1 s-1 and below and a substantial increase as greater than x2 for the purpose of this invention. The viscosity can be measured by a rotational shear rheometer.

Suitable rheological modifiers d3) by way of example are:
Polysaccharides including xanthan gum, and hydroxyethyl cellulose. Examples are Kelzan®, Rhodopol® G and 23, Satiaxane® CX911 and Natrosol® 250 range.
Clays including montmorillonite, bentonite, sepiolite, attapulgite, laponite, hectorite. Examples are Veegum® R, Van Gel® B, Bentone® 34, 38, CT, HC, EW, Pangel® M100, M200, M300, S, M, W, Attagel® 50, Laponite® RD,
Fumed and precipitated silica, examples are Aerosil® 200, Sipernat® 22.
Microcrystalline cellulose.

Preferred are xanthan gum, montmorillonite clays, bentonite clays and fumed silica. d4) Antifoam substances:
Suitable antifoam substances d4) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG® 1572 and SAG® 30 from Momentive [Dimethyl siloxanes and silicones, CAS No. 63148-62-9]. Preferred is SAG® 1572.

d5) Antifreeze agents:

Suitable antifreeze agents are all substances which can customarily be employed in agrochemical agents for this purpose. Suitable examples are propylene glycol, ethylene glycol, urea and glycerine. d6) Further formulants: Further suitable formulants d6) are selected from preservatives, biocides, colourants, pH adjusters, buffers, stabilisers, antioxidants, inert filling materials, humectants, crystal growth inhibitors or micronutirients.

By the way of example those are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1.2-benzisothiazol-3 (2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na2HPO4), sodium dihydrogen phosphate (NaH2PO4), potassium dihydrogen phosphate (KH2PO4), potassium hydrogen phosphate (K2HPO4), may be mentioned by way of example.

Suitable stabilisers and antioxidants are all substances which can customarily be employed in agrochemical agents for this purpose. Butylhydroxytoluene [3.5-Di-tert-butyl-4-hydroxytoluol, CAS-No. 128-37-0] is preferred.

Carriers e) are those which can customarily be used for this purpose in agrochemical formulations.

A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol (less than 1000 g/mol), different molecular weight grades of dimethyl polypropylene glycol (less than 1000 g/mol), dibenzyl ether
ketones (such as acetone, methyl ethyl ketone, methyl isobutyl ketone, cyclopentanone, cyclohexanone, cycloheptanone, acetophenone, propiophenone),
lactate esters, such as methyl lactate, ethyl lactate, propyl lactate, butyl lactate, 2-ethyl hexyl lactate
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, carbonate

Most preferred the carrier is water.

With the aid of the tank mix additives according to the invention it is possible to deliver active agrochemical to plants and/or their habitat in a particularly advantageous way.

The present invention is also directed to the use of agrochemical formulations containing the tank mix additive according to the invention for the application of the agrochemical active compounds contained to plants and/or their habitat.

With the tank mix additives of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

The application rate of the tank mix additive according to the invention can be varied within a relatively wide range. It is guided by the particular active agrochemicals and by their amount in the agrochemical formulations.

One further aspect of the invention is the use of a tank mix additive according to the invention in application of agrochemical compounds for controlling harmful organisms, wherein a formulation or spray liquid containing the tank mix additive is applied by an unmanned aerial vehicle UAV or an unmanned guided vehicle UGV or a spray nozzle device using pulse width modulation PWM. Formulations or spray liquids containing the tank mix additive are applied by customary methods, i.e., for example, by spraying, pouring or injecting, in particular by spraying, and most particular by spraying by unmanned aerial vehicles UAV or unmanned guided vehicles UGV or a spray nozzle device using pulse width modulation PWM.

### FIGURES

FIG. 1 shows spray droplet size %<100 microns for different spray volumes for recipes in example 1.

FIG. 2 shows spray droplet size %<100 microns for different spray volumes for recipes in example 2.

FIG. 3 shows spray droplet size %<100 microns for different spray volumes for recipes in example 3.

FIG. 4 shows spray droplet size %<100 microns for different PEO polymer molar mass and concentrations for example Polymers1.

FIG. 5 shows spray droplet size %<100 microns for different PEO polymer molar mass and PCF value for example Polymers2.

### MATERIALS TABLES

Materials

TABLE MAT1
Exemplified trade names and CAS-No's of preferred
drift reducing materials - Polymers a)

| Product | Chemical name | Cas No. | Supplier |
|---|---|---|---|
| Polyox ® WSR N12K | Poly(ethylene oxide) | 25322-68-3 | Dupont |
| | (average molecular | | |
| | weight 1 million g/mol) | | |
| Polyox ® WSR N60K | Poly(ethylene oxide) | 25322-68-3 | Dupont |
| | (average molecular | | |
| | weight 2 million g/mol) | | |
| Polyox ® WSR 301 | Poly(ethylene oxide) | 25322-68-3 | Dupont |
| | (average molecular | | |
| | weight 4 million g/mol) | | |
| Polyox ® WSR 308 | Poly(ethylene oxide) | 25322-68-3 | Dupont |
| | (average molecular | | |
| | weight 8 million g/mol) | | |
| AgRho ® DR2000 | hydroxypropyl guar | 68442-94-4. | Solvay |
| | | 39421-75-5 | |
| Jaguar ® HP-120 | hydroxypropyl guar | 68442-94-4. | Solvay |
| | | 39421-75-5 | |
| Jaguar ® HP-8 | hydroxypropyl guar | 68442-94-4. | Solvay |
| | | 39421-75-5 | |
| Jaguar ® 308 NB | hydroxypropyl guar | 68442-94-4. | Solvay |
| | | 39421-75-5 | |

TABLE MAT2
Exemplified trade names and CAS-No's of
preferred drift reducing materials - Oils b)

| Product | Chemical name | Cas No. | Supplier |
|---|---|---|---|
| Radia ® 7060 | methyl oleate | 112-62-9 | Oleon NV, BE |
| Radia ® 7120 | methyl palmitate | 112-39-0 | Oleon NV, BE |
| Agnique ME ® 18 RD-F, | Rape seed oil methyl | 67762-38-3. | Clariant |
| Edenor ® MESU | ester | 85586-25-0 | BASF |
| Crodamol ® EO | ethyl oleate | 111-62-6 | Croda |
| Estol ® 1514 | iso-propyl myristate | 110-27-0 | Croda |
| Crodamol ® IPM | | | |
| Radia ® 7732 | iso-propyl palmitate | 142-91-6 | Oleon NV, BE |
| Crodamol ® IPP | | | Croda, UK |
| Radia ® 7129 | ethylhexyl palmitate | 29806-73-3 | Oleon NV, BE |
| Crodamol ® OP | | | Croda, UK |
| Radia ® 7130 | ethylhexyl oleate | 26399-02-0 | Oleon NV, BE |
| Radia ® 7128 | ethylhexyl | 29806-75-5 | Oleon NV, BE |
| | myristate/laurate | | |
| | C12/C14 | | |
| Radia ® 7127 | ethylhexyl laurate | 20292-08-4 | Oleon NV, BE |
| Radia ® 7126 | ethylhexyl | 63321-70-0 | Oleon NV, BE |
| | caprylate/caprate C8/10 | | |
| Crodamol DA | di-isopropyl adipate | 6938-94-9 | Croda |
| Crodamol PC DAB | Propyleneglycol di-ester | 85409-09-2 | Croda |
| | of coconut fatty acids | | |
| Sunflower oil | Triglycerides from | 8001-21-6 | |
| | different C14-C18 fatty | | |
| | acids, predominantly | | |
| | unsaturated | | |
| Rapeseed oil | Triglycerides from | 8002-13-9 | |
| | different C14-C18 fatty | | |
| | acids, predominantly | | |
| | unsaturated | | |
| Corn oil | Triglycerides from | 8001-30-7 | |
| | different C14-C18 fatty | | |
| | acids, predominantly | | |
| | unsaturated | | |
| Soybean oil | Triglycerides from | 8001-22-7 | |
| | different C14-C18 fatty | | |
| | acids, predominantly | | |
| | unsaturated | | |
| Rice bran oil | Triglycerides from | 68553-81-1 | |
| | different C14-C18 fatty | | |
| | acids, predominantly | | |
| | unsaturated | | |
| Olive oil | | | |
| Peanut oil | | | |
| Radia ® 7104 | Caprylic, capric | 73398-61-5. | Oleon NV, BE |
| | triglycerides, neutral | 65381-09-1 | |
| | vegetable oil | | |
| Miglyol ® 812N | Glycerides, mixed | 73398-61-5. | IOI Oleochemical |
| | decanoyl and octanoyl | 65381-09-1 | |
| Exxsol ® D80 | Mineral oil | 64742-47-8 | Exxon |

TABLE MAT3
Exemplified trade names and CAS-No's of preferred spreading agents compounds c)

| Product | Chemical name | Cas No. | Supplier |
|---|---|---|---|
| Geropon ® DOS- | Dioctylsulfosuccinate sodium | 577-11-7 | Rhodia |
| PG | salt (65-70% in propylene | | |
| | glycol) | | |
| Synergen ® W 10 | Dioctylsulfosuccinate sodium | 577-11-7 | Clariant |
| | salt (65-70% in propylene | | |
| | glycol) | | |
| Aerosol ® OT 70 | Dioctylsulfosuccinate sodium | 577-11-7 | Cytec |
| PG | salt (65-70% in propylene | | |
| | glycol) | | |
| Lankropol KPH70 | Dioctylsulfosuccinate sodium | 577-11-7 | Nouryon |
| | salt (65-70% in propylene | | |
| | glycol) | | |
| Enviomet EM | Dioctylsulfosuccinate sodium | 577-11-7 | Innospec |
| 5669 | salt (65-70% in propylene | | |
| | glycol) | | |
| Surfynol ® S420 | 2,4,7,9-Tetramethyl-5-Decyne- | 9014-85-1 | Evonik |
| | 4,7-Diol ethoxylate (1 mole) | | |
| Surfynol ® S440 | 2,4,7,9-Tetramethyl-5-Decyne- | 9014-85-1 | Evonik |
| | 4,7-Diol ethoxylate (3.5 moles) | | |
| Surfynol ® S465 | 2,4,7,9-Tetramethyl-5-Decyne- | 9014-85-1 | Evonik |
| | 4,7-Diol ethoxylate (10 moles) | | |
| Surfynol ® S485 | 2,4,7,9-Tetramethyl-5-Decyne- | 9014-85-1 | Evonik |
| | 4,7-Diol ethoxylate (30 moles) | | |
| Break-Thru ® | 1-Hexanol, 3,5,5-trimethyl-, | 204336-40-3 | Evonik |
| Vibrant | ethoxylated, propoxylated | | |
| Genapol ® EP | C10-12 alcohol alkoxylate | | Clariant |
| 0244 | (PO + EO) | | |
| Synergen ® W06 | C11 alcohol alkoxylate (PO + EO) | | Clariant |
| Genapol ® EP | C12-15 alcohol alkoxylate | | Clariant |
| 2584 | (PO + EO) | | |
| Agnique ® | Oligomeric D-glucopyranose | 68515-73-1 | BASF |
| PG8107 | decyl octyl glycosides | | |
| Silwet ® L77 | 3-(2-methoxyethoxy)propyl- | 27306-78-1 | Momentive |
| | methyl- | | |
| | bis(trimethylsilyloxy)silane | | |
| Silwet ® 408 | 2-[3- | 67674-67-3 | Momentive |
| | [[dimethyl(trimethylsilyloxy)silyl]oxy- | | |
| | methyl- | | |
| | trimethylsilyloxysilyl]propoxy]ethanol | | |
| Silwet ® 806 | 3-[methyl- | 134180-76-0 | Momentive |
| | bis(trimethylsilyloxy)silyl]propan- | | |
| | 1-ol; 2-methyloxirane; oxirane | | |
| Break-thru ® S240 | 3-[methyl- | 134180-76-0 | Evonik |
| | bis(trimethylsilyloxy)silyl]propan- | | |
| | 1-ol; 2-methyloxirane; oxirane | | |
| Break-thru ® S278 | 3-(2-methoxyethoxy)propyl- | 27306-78-1 | Evonik |
| | methyl- | | |
| | bis(trimethylsilyloxy)silane | | |
| Silwet ® HS 312 | Polyalkyleneoxide silane | Not disclosed | Momentive |
| Silwet ® HS 604 | Poly(oxy-1,2-ethanediyl), alpha- | 881689-05-0 | Momentive |
| | (3-(dimethyl(2- | | |
| | (trimethylsilyl)ethyl)silyl)propyl)- | | |
| | omega-methoxy- | | |
| BreakThru ® OE | Siloxanes and Silicones, cetyl | 191044-49-2 | Evonik |
| 444 | Me, di-Me | | |

TABLE MAT4
Exemplified trade names and CAS-No's
of preferred uptake promoting additives c)

| Product | Chemical name | Cas No. | Supplier |
|---|---|---|---|
| Emulsogen ® EL 400 | Ethoxylated Castor Oil with 40 EO | 61791-12-6 | Clariant |
| Etocas ® 10 | Ethoxylated Castor Oil with 10 EO | 61791-12-6 | Croda |
| Crovol ® CR70G | fats and glyceridic oils, vegetable, | 70377-91-2 | Croda |
| | ethoxylated | | |
| Synperonic ® A3 | alcohol ethoxylate (C12/C15- | 68131-39-5 | Croda |
| | EO3) | | |
| Synperonic ® A7 | alcohol ethoxylate (C12/C15- | 68131-39-5 | Croda |
| | EO7) | | |
| Genapol ® X060 | alcohol ethoxylate (iso-C13-EO6) | 9043-30-5 | Clariant |
| Alkamuls ® A | Oleic acid, ethoxylated | 9004-96-0 | Solvay |
| Lucramul ® HOT | alcohol ethoxylate-propoxylate | 64366-70-7 | Levaco |
| 5902 | | | |
| Antarox B/848 | Butyl alcohol | 9038-95-3 | Solvay |
| | propoxylate/ethoxylate | | |
| Tween ® 80 | Sorbitan monooleate, ethoxylated | 9005-65-6 | Croda |
| | (20EO) | | |
| Tween ® 85 | Sorbitan trioleate, ethoxylated | 9005-70-3 | Croda |
| | (20EO) | | |
| Tween ® 20 | Sorbitan monolaurate, ethoxylated | 9005-64-5 | Croda |
| | (20EO) | | |
| Tween ® L-1505 | Sorbitan monolaurate, alkoxylated | | Croda |
| Genapol ® C 100 | Alcohols, coco, ethoxylated | 61791-13-7 | Clariant |

TABLE MAT5
Exemplified trade names of preferred rain-fast additives d)

| Product | Chemical name | Tg | | MFFT | Supplier |
|---|---|---|---|---|---|
| Atplus ® FA | Aqueous styrene acrylic co- | <30° | C. | | Croda |
| | polymer emulsion dispersion | | | | |
| Acronal ® V215 | aqueous acrylate co-polymer | −43° | C. | | BASF |
| Acronal ® V115 | dispersion containing carboxylic | −58° | C. | | |
| Acronal ® A245 | groups. | −45° | C. | | |
| Acronal ® A240 | | −30° | C. | | |
| Acronal ® A225 | | −45° | C. | | |
| Acronal ® A145 | | −45° | C. | | |
| Acronal ® 500 D | aqueous acrylic co-polymer | −13° | C. | | BASF |
| Acronal ® S 201 | dispersion | −25° | C. | | |
| Acronal ® DS 3618 | aqueous acrylic ester co- | −40° | C. | | BASF |
| Acronal ® 3612 | polymer dispersion | +12° | C. | | |
| Acronal ® V 212 | | −40° | C. | | |
| Acronal ® DS 3502 | | +4° | C. | | |
| Acronal ® S 400 | | −8° | C. | | |
| Licomer ® ADH205 | aqueous acrylic ester co- | <30° | C. | | Michelman |
| Licomer ® ADH203 | polymer dispersion containing | | | | |
| | carboxylic groups. | | | | |
| Primal ® CM-160 | Aqueous acrylic copolymer | | | | DOW |
| Primal ® CM-330 | emulsion polymer | | | | |
| Axilat ® UltraGreen | Aqueous acrylic emulsion | −15° | C. | 0° C. | Synthomer |

| | | |
|---|---|---|
| 5500 | polymer | |
| Povol ® 26/88 | Polyvinyl alcohol | Kuraray |

TABLE MAT6
Exemplified trade names and CAS-No's of preferred other formulants d)

| Product | Chemical name | Cas No. | Supplier |
|---|---|---|---|
| Synperonic ® | block-copolymer of polyethylene | 9003-11-6 | Croda |
| PE/F127 | oxide and polypropylene oxide | | |
| Synperonic ® | block-copolymer of polyethylene | 9003-11-6 | Croda |
| PE/L62 | oxide and polypropylene oxide | | |
| Xanthan | Polysaccharide | 11138-66-2 | |
| Proxel ® GXL | 1.2-benzisothiazol-3(2H)-one | 2634-33-5 | Arch Chemicals |
| Kathon ® CG/ICP | 5-chloro-2-methyl-4-isothiazolin- | 26172-55-4 plus | Dow |
| | 3-one plus 2-methyl-4- | 2682-20-4 | |
| | isothiazolin-3-one | | |
| Propylene glycol | 1,2-Propylene glycol | 57-55-6 | |
| Glycerol | Propane-1,2,3-triol | 56-81-5 | |
| SAG ® 1572 | Dimethyl siloxanes and silicones | 63148-62-9 | Momentive |
| Atlox ® 4913 | methyl methacrylate graft | 119724-54-8 | Croda |
| | copolymer with polyethylene | | |
| | glycol | | |
| Atlox ® 4894 | Fatty Alcohol Ethoxylate | 68131-39-5 | Croda |
| Atlas ® G 5000 | Oxirane, methyl-, polymer with | 9038-95-3 | Croda |
| | oxirane, monobutyl ether | | |
| Geropon ® T36 | Sodium polycarboxylate | 37199-81-8 | Solvay |
| Lucramul ® PS 29 | Poly(oxy-1,2-ethanediyl),. alpha.- | 104376-75-2 | Levaco |
| | phenyl-.omega.-hydroxy-, | | |
| | styrenated | | |
| Soprophor ® TS/29 | Poly(oxy-1,2-ethanediyl),. alpha.- | 104376-75-2 | Solvay |
| | phenyl-.omega.-hydroxy-, | | |
| | styrenated | | |
| Soprophor ® TS/54 | Poly(oxy-1,2-ethanediyl),. alpha.- | 104376-75-2 | Solvay |
| | phenyl-.omega.-hydroxy-, | | |
| | styrenated | | |
| Morwet ® IP | Naphthalenesulfonic acid, bis(1- | 68909-82-0 | Akzo Nobel |
| | methylethyl)-, Me derivs., sodium | | |
| | salts | | |
| Van Gel ® B | Smectite-group minerals | 12199-37-0 | Vanderbilt |
| Veegum ® R | | | |
| Aerosil R972 | Silane, dichlorodimethyl-, reaction | 68611-44-9 | Evonik |
| | products with silica | | |
| Silcolapse ® 454 | Polydimethylsiloxanes and silica | 9016-00-6 | Bluestar Silicones |
| Silcolapse ® 426R | Polydimethylsiloxanes and silica | 9016-00-6 | Bluestar Silicones |
| Rhodopol ® 23 | Polysaccharide | 11138-66-2 | Solvay |
| Acticide ® MBS | Mixture of 2-methyl-4-isothiazolin- | 2682-20-4 | Thor GmbH |
| | 3-one (MIT) and 1,2- | 2634-33-5 | |
| | benzisothiazolin-3-one (BIT) in | | |
| | water | | |
| Sokalan ® K 30 | Polyvinylpyrrolidone | 9003-39-8 | BASF |
| Supragil ® WP | Sodium diisopropyl naphthalene | 1322-93-6 | Solvay |
| | sulfonate | | |
| Morwet ® D-425 | Sodium naphthalene sulphonate | 577773-56-9 | Akzo Nobel, |
| | formaldehyde condensate | 68425-94-5 | Nouryon |
| | | 9008-63-3 | |
| Soprophor ® 4 D 384 | Tristyrylphenol ethoxylate sulfate | 119432-41-6 | Solvay |
| | (16 EO) ammonium salt | | |
| Soprophor ® FLK | Poly(oxy-1,2-ethanediyl), alpha.- | 163436-84-8 | Solvay |
| | 2,4,6-tris(1- | | |
| | phenylethyl)phenyl-.omega.- | | |
| | hydroxy-, phosphate, potassium | | |
| | salt | | |
| Rhodorsil ® Antim | absorbed poly(dimethylsiloxane) | unknown | Solvay |
| EP 6703 | antifoam | | |
| Kaolin Tec 1 | Aluminium hydrosilicate | 1318-74-7 | Ziegler & Co. |
| | | 1332-58-7 | GmbH |
| Sipernat ® 22 S | synthetic amorphous silica (silicon | 112926-00-8 | Evonik |
| | dioxide) | 7631-86-9 | |
| Rhodacal ® 60 BE | Calcium- | 26264-06-2 | Solvay |
| | dodecylbenzenesulphonate in 2- | 104-76-7 | |
| | Ethylhexanol | | |
| Sodium hydrogen | Na₂HPO₄ | 7558-79-4 | |
| phosphate | | | |
| Sodium dihydrogen | NaH₂PO₄ | 7558-80-7 | |
| phosphate | | | |
| Citric Acid | C₆H₈O₇ | 77-92-9 | |
| Glycerine | C₃H₈O₃ | 56-81-5 | |
| Urea | CH₄N₂O | 57-13-6 | |
| Supragil WP | Sodium diisopropyl naphthalene | 1322-93-6 | Solvay |
| | sulfonate | | |
| Morwet D-425 | Naphthalene sulphonate | 9008-63-3 | Nouryon |
| | formaldehyde condensate Na salt | | |
| Sokalan K 30 | Polyvinylpyrrolidone | 9003-39-8 | BASF |
| Silcolapse 454 | Polydimethylsiloxane | 7631-86-9 | Solvay |
| | | 9016-00-6 | |
| Sipernat 50 S | synthetic amorphous silica (silicon | 112926-00-8 | Evonik |
| | dioxide) | 7631-86-9 | |
| Kaolin Tec 1 | Aluminiumhydrosilicate | 1318-74-7 | Ziegler & Co. |
| | | 1332-58-7 | GmbH |

### Experimental Methods

Method 1: Tank mix additive preparation method

The method of the preparation of liquid tank mix compositions are known in the art and can be produced by known methods familiar to those skilled in the art. A 1-4% solution of drift reducing polymer (a) was prepared by mixing the polymer in glycerine (25%) and pouring this mixture into water (to 100%) with stirring until homogeneous. A 50% oil in water emulsion of drift reducing oil (b) was prepared by adding oil (50%) to water (49%) and Synperonic PE/F127 (1%) in solution under high shear mixing (Ultra-Turrax®) to achieve a droplet size of 1 to 4 microns (Dv50). The other formulants (d), the spreading and/or uptake promoting additive(s) (c) were mixed with the remaining water with stirring, followed by the polymer (a) solution prepared above, the 50% oil (b) emulsion prepared above with low shear stirring until homogeneous. Further water (e) was added as required to give the final amount. Finally, the pH was adjusted if needed with acid or base (d).

The polymer (a) solution is prepared according to the viscosity concentration limit and content required in the recipe. Typical example values are: Polyox WSR301 (1-2%), Polyox WSR N60K (1-3%), Polyox WSR N12K (2-4%), AgRho DR2000 (1-2%).

Method 2: Spray droplet size P15 measurement

The compositions were diluted in water (deionised) to the required concentration, sprayed through a TeeJet® TP8002EVS nozzle at a pressure of 3 bar and the droplet size spectra measured with an Oxford Lasers VisiSize P15 which captures images of the spray droplets and measures their size. The spray nozzle was positioned 20 cm above the image capture point and slowly moved by a motorised slider across the image capture window of the VisiSize P15, ensuring that the complete width of the spray fan was measured. A minimum of 5000 to 10000 droplet images were captured. The droplet size spectra were calculated by the instrument software as volume % less than 100 microns and volume % less than 150 microns, which are commonly regarded as the driftable fraction of the spray droplets.

### EXAMPLES

### Example 1

TABLE 1.1
Recipes 1, 2, 3, 4, 5 and 6.

| | | | | Recipe 4 | Recipe 5 | Recipe 6 |
|---|---|---|---|---|---|---|
| | | | | containing | containing | containing |
| | | | | drift | drift | drift |
| | | Recipe 2 | | reducing | reducing | reducing |
| | | containing | Recipe 3 | polymer | polymer | polymer |
| | | drift | containing | (a) and | (a) and | (a) and |
| | | reducing | drift | drift | drift | drift |
| | Recipe 1 | polymer | reducing | reducing | reducing | reducing |
| Component (g/l) | reference | (a) | oil (b) | oil (b) | oil (b) | oil (b) |
| Polyox ® WSR | 0.0 | 8.0 | 0.0 | 8.0 | 12.0 | 2.0 |
| N12K (PEO | | | | | | |
| 1 mio) | | | | | | |
| Rapeseed oil | 0.0 | 00.0 | 15.0 | 15.0 | 15.0 | 15.0 |
| Synperonic ® | 0.0 | 0.0 | 1.5 | 1.5 | 1.5 | 1.5 |
| PE/F127 | | | | | | |
| Crovol ® CR70G | 180.0 | 180.0 | 180.0 | 180.0 | 180.0 | 180.0 |
| Proxel ® GXL | 1.2 | 1.2 | 1.2 | 1.2 | 1.2 | 1.2 |
| Kathon ® CG/ICP | 0.8 | 0.8 | 0.8 | 0.8 | 0.8 | 0.8 |
| Glycerine | 50.0 | 50.0 | 50.0 | 50.0 | 50.0 | 50.0 |
| SAG ® 1572 | 3.0 | 3.0 | 3.0 | 3.0 | 3.0 | 3.0 |
| Na₂HPO₄ (Buffer | 1.5 | 1.5 | 1.5 | 1.5 | 1.5 | 1.5 |
| solution pH = 7) | | | | | | |
| NaH₂PO₄ (Buffer | 0.8 | 0.8 | 0.8 | 0.8 | 0.8 | 0.8 |
| solution pH = 7) | | | | | | |
| Water (add to 1 | To volume | To volume | To volume | To volume | To volume | To volume |
| litre) | (~775) | (~767) | (~758) | (~750) | (~746) | (~756) |

The method of preparation used was according to Method 1.

### Physical Aspect

The physical aspect with regard to viscosity was assessed visually.

TABLE 1.2
Physical aspect of recipes.

| | Drift reducing polymer (a) | |
|---|---|---|
| | concentration in recipe | |
| Recipe | g/l | Physical aspect |
| 1 | 0.0 | Pourable liquid. |
| 2 | 8.0 | Pourable liquid. |
| 3 | 0.0 | Pourable liquid. |
| 4 | 8.0 | Pourable liquid. |
| 5 | 12.0 | Pourable liquid. |
| 6 | 2.0 | Pourable liquid. |

The results show that the polymer Polyox® WSR N12K can be incorporated into adjuvant tank mix recipes at concentrations from 2 to 12 g/L without the sample being too viscous.

Spray droplet size

The spray droplet size was determined according to Method 2.

TABLE 1.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (a) | (b) | agent (c) | vol <100 | vol <150 |
| | Spray | concentration | concentration | concentration | microns) | microns) |
| | volume | in recipe | in recipe | in recipe | from recipe | from recipe |
| Recipe | l/ha | g/l | g/l | g/l | % vol | % vol |
| 1 | 1000 | 0.0 | 0.0 | 180.0 | 21.9 | 45.3 |
| | 200 | | | | 23.8 | 46.9 |
| | 40 | | | | 24.4 | 49.4 |
| | 20 | | | | 25.6 | 52.5 |
| | 10 | | | | 25 | 52.3 |
| | 5 | | | | 25.1 | 52.1 |
| 2 | 1000 | 8.0 | 0.0 | 180.0 | 21 | 43.3 |
| | 200 | | | | 20.5 | 41.9 |
| | 40 | | | | 16.8 | 37.9 |
| | 20 | | | | 14.1 | 34.5 |
| | 10 | | | | 8.7 | 21.9 |
| | 5 | | | | 4.7 | 14 |
| 3 | 1000 | 0.0 | 15.0 | 180.0 | 13.1 | 33.4 |
| | 200 | | | | 11.9 | 30.7 |
| | 40 | | | | 21.1 | 44 |
| | 20 | | | | 23.5 | 49.3 |
| | 10 | | | | 24.1 | 51.5 |
| | 5 | | | | 24.3 | 50.4 |
| 4 | 1000 | 8.0 | 15.0 | 180.0 | 15.4 | 35.4 |
| | 200 | | | | 16.2 | 37.7 |
| | 40 | | | | 20.8 | 45.9 |
| | 20 | | | | 14.7 | 35.2 |
| | 10 | | | | 8.7 | 24.6 |
| | 5 | | | | 6.5 | 17.5 |
| 5 | 1000 | 12.0 | 15.0 | 180.0 | 14.6 | 35.6 |
| | 200 | | | | 18.7 | 41.3 |
| | 40 | | | | 16.4 | 40.1 |
| | 20 | | | | 10.9 | 29.1 |
| | 10 | | | | 7.6 | 20.2 |
| | 5 | | | | 3.8 | 11.2 |
| 6 | 1000 | 2.0 | 15.0 | 180.0 | 12.9 | 35.7 |
| | 200 | | | | 12.2 | 33.5 |
| | 40 | | | | 16.6 | 40.7 |
| | 20 | | | | 21.2 | 49.7 |
| | 10 | | | | 19.6 | 45.6 |
| | 5 | | | | 14.4 | 35.8 |

Tank mix additive sprayed at a dose rate of 0.5 l/ha.

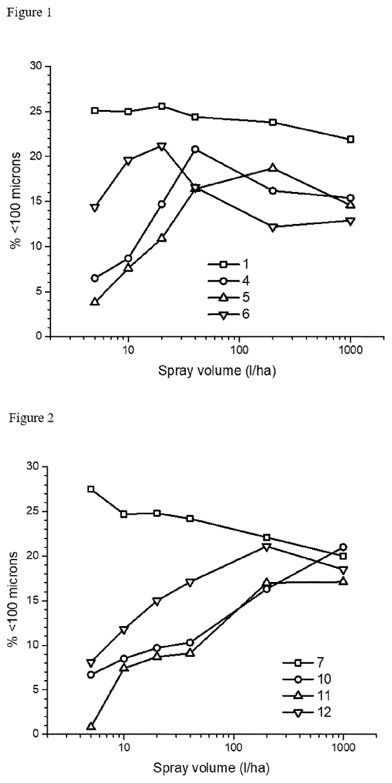

The results show that the combination of polymer Polyox® WSR N12K (PEO 1 million) and rapeseed oil can reduce the driftable fraction of spray droplets <100 microns and <150 microns over the spray volume range of 5 to 1000 l/ha (see FIG. 1). The polymer alone can only reduce the driftable fraction of spray droplets at lower spray volumes while the oil alone can only reduce the driftable fraction of spray droplets at higher spray volumes, and it is only the combination of both that is effective at both lower and higher spray volumes. Furthermore, the amount of the polymer Polyox® WSR N12K is important, 2 g/l corresponding to 1 g/ha has a weaker effect than 8 and 12 g/l corresponding to 4 and 6 g/ha. It is also surprising how low an amount of the polymer Polyox® WSR N12K and rapeseed oil is required to reduce the driftable fraction of spray droplets, with these amounts well below the typical use rates (g/ha) for these materials.

TABLE 1.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (a) | oil (b) | agent (c) |
| | Spray | concentration | concentration | concentration |
| | volume | in spray | in spray | in spray |
| Recipe | l/ha | liquid g/l | liquid g/l | liquid g/l |
| 1 | 1000 | 0.0 | 0.0 | 0.09 |
| | 200 | 0.0 | 0.0 | 0.45 |
| | 40 | 0.0 | 0.0 | 2.25 |
| | 20 | 0.0 | 0.0 | 4.5 |
| | 10 | 0.0 | 0.0 | 9.0 |
| | 5 | 0.0 | 0.0 | 18.0 |
| 2 | 1000 | 0.004 | 0.0 | 0.09 |
| | 200 | 0.02 | 0.0 | 0.45 |
| | 40 | 0.1 | 0.0 | 2.25 |
| | 20 | 0.2 | 0.0 | 4.5 |
| | 10 | 0.4 | 0.0 | 9.0 |
| | 5 | 0.8 | 0.0 | 18.0 |
| 3 | 1000 | 0.0 | 0.0075 | 0.09 |
| | 200 | 0.0 | 0.0375 | 0.45 |
| | 40 | 0.0 | 0.1875 | 2.25 |
| | 20 | 0.0 | 0.375 | 4.5 |
| | 10 | 0.0 | 0.75 | 9.0 |
| | 5 | 0.0 | 1.5 | 18.0 |
| 4 | 1000 | 0.004 | 0.0075 | 0.09 |
| | 200 | 0.02 | 0.0375 | 0.45 |
| | 40 | 0.1 | 0.1875 | 2.25 |
| | 20 | 0.2 | 0.375 | 4.5 |
| | 10 | 0.4 | 0.75 | 9.0 |
| | 5 | 0.8 | 1.5 | 18.0 |
| 5 | 1000 | 0.006 | 0.0075 | 0.09 |
| | 200 | 0.03 | 0.0375 | 0.45 |
| | 40 | 0.15 | 0.1875 | 2.25 |
| | 20 | 0.3 | 0.375 | 4.5 |
| | 10 | 0.6 | 0.75 | 9.0 |
| | 5 | 1.2 | 1.5 | 18.0 |
| 6 | 1000 | 0.001 | 0.0075 | 0.09 |
| | 200 | 0.005 | 0.0375 | 0.45 |
| | 40 | 0.025 | 0.1875 | 2.25 |
| | 20 | 0.05 | 0.375 | 4.5 |
| | 10 | 0.1 | 0.75 | 9.0 |
| | 5 | 0.2 | 1.5 | 18.0 |

Tank mix additive sprayed at a dose rate of 0.5 l/ha.

### Example 2

TABLE 2.1
Recipes 7, 8, 9, 10, 11 and 12.

| | | | | Recipe 10 | Recipe 11 | Recipe 12 |
|---|---|---|---|---|---|---|
| | | | | containing | containing | containing |
| | | | | drift | drift | drift |
| | | Recipe 8 | | reducing | reducing | reducing |
| | | containing | Recipe 9 | polymer | polymer | polymer |
| | | drift | containing | (a) and | (a) and | (a) and |
| | | reducing | drift | drift | drift | drift |
| | Recipe 7 | polymer | reducing | reducing | reducing | reducing |
| Component (g/l) | reference | (a) | oil (b) | oil (b) | oil (b) | oil (b) |
| Polyox ® WSR | 0.0 | 2.2 | 0.0 | 2.2 | 4.0 | 1.0 |
| 301 (PEO 4 mio) | | | | | | |
| Rapeseed oil | 0.0 | 00.0 | 15.0 | 15.0 | 15.0 | 15.0 |
| methyl ester | | | | | | |
| Synperonic ® | 0.0 | 0.0 | 1.5 | 1.5 | 1.5 | 1.5 |
| PE/F127 | | | | | | |
| Geropon ® DOS | 20.0 | 20.0 | 20.0 | 20.0 | 20.0 | 20.0 |
| 70PG | | | | | | |
| Silwet ® 408 | 50.0 | 50.0 | 50.0 | 50.0 | 50.0 | 50.0 |
| Crovol ® CR70G | 100.0 | 100.0 | 100.0 | 100.0 | 100.0 | 100.0 |
| Lucramul ® HOT | 40.0 | 40.0 | 40.0 | 40.0 | 40.0 | 40.0 |
| 5902 | | | | | | |
| Atplus ® FA | 30.0 | 30.0 | 30.0 | 30.0 | 30.0 | 30.0 |
| Proxel ® GXL | 1.2 | 1.2 | 1.2 | 1.2 | 1.2 | 1.2 |
| Kathon ® CG/ICP | 0.8 | 0.8 | 0.8 | 0.8 | 0.8 | 0.8 |
| Glycerine | 50.0 | 50.0 | 50.0 | 50.0 | 50.0 | 50.0 |
| SAG ® 1572 | 3.0 | 3.0 | 3.0 | 3.0 | 3.0 | 3.0 |
| Na₂HPO₄ (Buffer | 1.5 | 1.5 | 1.5 | 1.5 | 1.5 | 1.5 |
| solution pH = 7) | | | | | | |
| NaH₂PO₄ (Buffer | 0.8 | 0.8 | 0.8 | 0.8 | 0.8 | 0.8 |
| solution pH = 7) | | | | | | |
| Water (add to 1 | To volume | To volume | To volume | To volume | To volume | To volume |
| litre) | (~713) | (~710) | (~696) | (~694) | (~692) | (~695) |

The method of preparation used was according to Method 1.

### Physical Aspect

The physical aspect with regard to viscosity was assessed visually.

TABLE 2.2
Physical aspect of recipes.

| | Drift reducing polymer (a) | |
|---|---|---|
| | concentration in recipe | |
| Recipe | g/l | Physical aspect |
| 7 | 0.0 | Pourable liquid. |
| 8 | 2.2 | Pourable liquid. |
| 9 | 0.0 | Pourable liquid. |
| 10 | 2.2 | Pourable liquid. |
| 11 | 4.0 | Pourable liquid. |
| 12 | 1.0 | Pourable liquid. |

The results show that the polymer Polyox® WSR301 can be incorporated into adjuvant tank mix recipes at concentrations from 1 to 4 g/L without the sample being too viscous.

Spray droplet size

The spray droplet size was determined according to Method 2.

TABLE 2.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (a) | (b) | agent (c) | vol <100 | vol <150 |
| | Spray | concentration | concentration | concentration | microns) | microns) |
| | volume | in recipe | in recipe | in recipe | from recipe | from recipe |
| Recipe | l/ha | g/l | g/l | g/l | % vol | % vol |
| 7 | 1000 | 0.0 | 0.0 | 210.0 | 20.0 | 42.1 |
| | 200 | | | | 22.1 | 44.7 |
| | 40 | | | | 24.2 | 49.5 |
| | 20 | | | | 24.8 | 50.8 |
| | 10 | | | | 24.7 | 52.5 |
| | 5 | | | | 27.5 | 55.1 |
| 8 | 1000 | 2.2 | 0.0 | 210.0 | 19.8 | 40.8 |
| | 200 | | | | 16.6 | 35 |
| | 40 | | | | 10.3 | 26.2 |
| | 20 | | | | 9.7 | 21.8 |
| | 10 | | | | 8.9 | 20.8 |
| | 5 | | | | 4 | 6.9 |
| 9 | 1000 | 0.0 | 15.0 | 210.0 | 20.2 | 42 |
| | 200 | | | | 21.1 | 43.9 |
| | 40 | | | | 22.6 | 48 |
| | 20 | | | | 24.8 | 50.8 |
| | 10 | | | | 24.9 | 52.6 |
| | 5 | | | | 28 | 54.3 |
| 10 | 1000 | 2.2 | 15.0 | 210.0 | 21 | 41.6 |
| | 200 | | | | 16.3 | 34.1 |
| | 40 | | | | 10.3 | 26.6 |
| | 20 | | | | 9.7 | 21.9 |
| | 10 | | | | 8.5 | 16.9 |
| | 5 | | | | 6.7 | 12.8 |
| 11 | 1000 | 4.0 | 15.0 | 210.0 | 17.1 | 39.5 |
| | 200 | | | | 17 | 37.7 |
| | 40 | | | | 9.1 | 23.1 |
| | 20 | | | | 8.7 | 18.7 |
| | 10 | | | | 7.4 | 14.2 |
| | 5 | | | | 0.8 | 0.8 |
| 12 | 1000 | 1.0 | 15.0 | 210.0 | 41.2 | 119.7 |
| | 200 | | | | 45.7 | 115.4 |
| | 40 | | | | 40.2 | 120.9 |
| | 20 | | | | 36.8 | 125.5 |
| | 10 | | | | 29.1 | 133.3 |
| | 5 | | | | 18.2 | 147.1 |

Tank mix additive sprayed at a dose rate of 0.5 l/ha.

The results show that the combination of polymer Polyox® WSR 301 (PEO 4 million) and rapeseed oil methyl ester can reduce the driftable fraction of spray droplets <100 microns and <150 microns over the spray volume range of 5 to 1000 l/ha (see FIG. 2). Furthermore, the amount of the polymer Polyox® WSR 301 in the recipe is important, 1 g/l corresponding to 0.5 g/ha has a weaker effect than 2.2 and 4 g/l corresponding to 1.1 and 2 g/ha. It is also surprising how low an amount of the polymer Polyox® WSR 301 and rapeseed oil methyl ester is required to reduce the driftable fraction of spray droplets, with these amounts well below the typical use rates (g/ha) for these materials.

TABLE 2.4
Concentrations of drift reducing polymer, drift reducing oil and
spreading and uptake promoting agents in the spray dilution.

| | | Drift reducing | Drift reducing | Spreading and |
|---|---|---|---|---|
| | | polymer (a) | oil (b) | uptake promoting |
| | Spray | concentration | concentration | agent (c) |
| | volume | in spray | in spray | concentration in |
| Recipe | l/ha | liquid g/l | liquid g/l | spray liquid g/l |
| 7 | 1000 | 0.0 | 0.0 | 0.105 |
| | 200 | 0.0 | 0.0 | 0.525 |
| | 40 | 0.0 | 0.0 | 2.625 |
| | 20 | 0.0 | 0.0 | 5.25 |
| | 10 | 0.0 | 0.0 | 10.5 |
| | 5 | 0.0 | 0.0 | 21.0 |
| 8 | 1000 | 0.0011 | 0.0 | 0.105 |
| | 200 | 0.0055 | 0.0 | 0.525 |
| | 40 | 0.0275 | 0.0 | 2.625 |
| | 20 | 0.055 | 0.0 | 5.25 |
| | 10 | 0.11 | 0.0 | 10.5 |
| | 5 | 0.22 | 0.0 | 21.0 |
| 9 | 1000 | 0.0 | 0.0075 | 0.105 |
| | 200 | 0.0 | 0.0375 | 0.525 |
| | 40 | 0.0 | 0.1875 | 2.625 |
| | 20 | 0.0 | 0.375 | 5.25 |
| | 10 | 0.0 | 0.75 | 10.5 |
| | 5 | 0.0 | 1.5 | 21.0 |
| 10 | 1000 | 0.0011 | 0.0075 | 0.105 |
| | 200 | 0.0055 | 0.0375 | 0.525 |
| | 40 | 0.0275 | 0.1875 | 2.625 |
| | 20 | 0.055 | 0.375 | 5.25 |
| | 10 | 0.11 | 0.75 | 10.5 |
| | 5 | 0.22 | 1.5 | 21.0 |
| 11 | 1000 | 0.002 | 0.0075 | 0.105 |
| | 200 | 0.01 | 0.0375 | 0.525 |
| | 40 | 0.05 | 0.1875 | 2.625 |
| | 20 | 0.1 | 0.375 | 5.25 |
| | 10 | 0.2 | 0.75 | 10.5 |
| | 5 | 0.4 | 1.5 | 21.0 |
| 12 | 1000 | 0.0005 | 0.0075 | 0.105 |
| | 200 | 0.0025 | 0.0375 | 0.525 |
| | 40 | 0.0125 | 0.1875 | 2.625 |
| | 20 | 0.025 | 0.375 | 5.25 |
| | 10 | 0.05 | 0.75 | 10.5 |
| | 5 | 0.1 | 1.5 | 21.0 |

Tank mix additive sprayed at a dose rate of 0.5 l/ha.

### Example 3

TABLE 3.1
Recipes 13, 14, 15 and 16.

| | | | | Recipe 16 |
|---|---|---|---|---|
| | | | | containing |
| | | | | drift |
| | | Recipe 14 | | reducing |
| | | containing | Recipe 15 | polymer |
| | | drift | containing | (a) and |
| | Recipe | reducing | drift | drift |
| | 13 | polymer | reducing | reducing |
| Component (g/l) | reference | (a) | oil (b) | oil (b) |
| Polyox ® WSR | 0.0 | 4.4 | 0.0 | 4.4 |
| N60K (PEO | | | | |
| 2 mio) | | | | |
| Sunflower oil | 0.0 | 00.0 | 20.0 | 20.0 |
| Synperonic ® | 0.0 | 0.0 | 2.0 | 2.0 |
| PE/F127 | | | | |
| Geropon ® DOS | 30.0 | 30.0 | 30.0 | 30.0 |
| PG70 | | | | |
| Silwet ® 806 | 80.0 | 80.0 | 80.0 | 80.0 |
| Lucramul ® HOT | 60.0 | 60.0 | 60.0 | 60.0 |
| 5902 | | | | |
| Proxel ® GXL | 1.2 | 1.2 | 1.2 | 1.2 |
| Kathon ® CG/ICP | 0.8 | 0.8 | 0.8 | 0.8 |
| Glycerine | 80.0 | 80.0 | 80.0 | 80.0 |
| SAG ® 1572 | 3.0 | 3.0 | 3.0 | 3.0 |
| Na₂HPO₄ (Buffer | 1.5 | 1.5 | 1.5 | 1.5 |
| solution pH = 7) | | | | |
| NaH₂PO₄ (Buffer | 0.8 | 0.8 | 0.8 | 0.8 |
| solution pH = 7) | | | | |
| Water (add to 1 | To | To volume | To volume | To volume |
| litre) | volume | (~747) | (~732) | (~727) |
| | (~752) | | | |

The method of preparation used was according to Method 1.

Physical Aspect

The physical aspect with regard to viscosity was assessed visually.

TABLE 1.2
Physical aspect of recipes.

| | Drift reducing polymer (a) | |
|---|---|---|
| | concentration in recipe | |
| Recipe | g/l | Physical aspect |
| 13 | 0.0 | Pourable liquid. |
| 14 | 2.0 | Pourable liquid. |
| 15 | 2.0 | Pourable liquid. |
| 16 | 2.0 | Pourable liquid. |

The results show that the polymer Polyox® WSR N60K can be incorporated into tank mix adjuvant recipes at a concentration of 4.4 g/L without the sample being too viscous.

Spray droplet size

The spray droplet size was determined according to method 2.

TABLE 3.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (a) | (b) | agent (c) | vol <100 | vol <150 |
| | Spray | concentration | concentration | concentration | microns) | microns) |
| | volume | in recipe | in recipe | in recipe | from recipe | from recipe |
| Recipe | l/ha | g/l | g/l | g/l | % vol | % vol |
| 13 | 1000 | 0.0 | 0.0 | 170.0 | 19.1 | 41.5 |
| | 200 | | | | 19.1 | 41.6 |
| | 40 | | | | 25.0 | 53.3 |
| | 20 | | | | 25.6 | 54.2 |
| | 10 | | | | 26.4 | 56.0 |
| | 5 | | | | 25.5 | 55.4 |
| 14 | 1000 | 4.4 | 0.0 | 170.0 | 20.4 | 42.1 |
| | 200 | | | | 17.5 | 39.3 |
| | 40 | | | | 13 | 30.9 |
| | 20 | | | | 10.4 | 24.3 |
| | 10 | | | | 6.6 | 15.7 |
| | 5 | | | | 6.7 | 15.0 |
| 15 | 1000 | 0.0 | 20.0 | 170.0 | 17.6 | 38.2 |
| | 200 | | | | 19.0 | 40.1 |
| | 40 | | | | 22.9 | 47.9 |
| | 20 | | | | 26.5 | 52.7 |
| | 10 | | | | 24.0 | 52.5 |
| | 5 | | | | 28.1 | 55.2 |
| 16 | 1000 | 4.4 | 20.0 | 170.0 | 18.4 | 38.2 |
| | 200 | | | | 15.9 | 37.4 |
| | 40 | | | | 15.7 | 36.6 |
| | 20 | | | | 10.7 | 24.0 |
| | 10 | | | | 6.6 | 15.0 |
| | 5 | | | | 6.2 | 14.3 |

Tank mix additive sprayed at a dose rate of 0.5 l/ha.

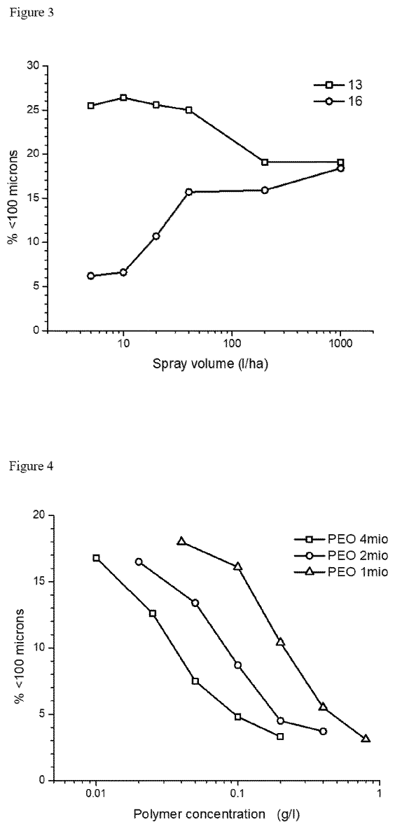

The results show that the combination of polymer Polyox® WSR N60K and sunflower oil can reduce the driftable fraction of spray droplets <100 microns and <150 microns over the spray volume range of 5 to 200 l/ha (see FIG. 3). It is also surprising how low an amount of the polymer Polyox® WSR N60K (2.2 g/ha) and sunflower oil (10 g/ha) is required to reduce the driftable fraction of spray droplets, with these amounts well below the typical use rates (g/ha) for these materials.

TABLE 3.4
Concentrations of drift reducing polymer, drift reducing oil and
spreading and uptake promoting agents in the spray dilution.

| | | Drift reducing | Drift reducing | Spreading and |
|---|---|---|---|---|
| | | polymer (a) | oil (b) | uptake promoting |
| | Spray | concentration | concentration | agent (c) |
| | volume | in spray | in spray | concentration in |
| Recipe | l/ha | liquid g/l | liquid g/l | spray liquid g/l |
| 13 | 1000 | 0.0 | 0.0 | 0.085 |
| | 200 | 0.0 | 0.0 | 0.425 |
| | 40 | 0.0 | 0.0 | 2.125 |
| | 20 | 0.0 | 0.0 | 4.25 |
| | 10 | 0.0 | 0.0 | 8.5 |
| | 5 | 0.0 | 0.0 | 17.0 |
| 14 | 1000 | 0.0022 | 0.0 | 0.085 |
| | 200 | 0.011 | 0.0 | 0.425 |
| | 40 | 0.055 | 0.0 | 2.125 |
| | 20 | 0.11 | 0.0 | 4.25 |
| | 10 | 0.22 | 0.0 | 8.5 |
| | 5 | 0.44 | 0.0 | 17.0 |
| 15 | 1000 | 0.0 | 0.01 | 0.085 |
| | 200 | 0.0 | 0.05 | 0.425 |
| | 40 | 0.0 | 0.25 | 2.125 |
| | 20 | 0.0 | 0.5 | 4.25 |
| | 10 | 0.0 | 1.0 | 8.5 |
| | 5 | 0.0 | 2.0 | 17.0 |
| 16 | 1000 | 0.0022 | 0.01 | 0.085 |
| | 200 | 0.011 | 0.05 | 0.425 |
| | 40 | 0.055 | 0.25 | 2.125 |
| | 20 | 0.11 | 0.5 | 4.25 |
| | 10 | 0.22 | 1.0 | 8.5 |
| | 5 | 0.44 | 2.0 | 17.0 |

Tank mix additive sprayed at a dose rate of 0.5 l/ha.

### Example Polymers1

TABLE P1.1
Spray droplet size for aqueous polymer solutions

| | | Amount of | Amount of | | |
|---|---|---|---|---|---|
| | | driftable | driftable | % reduction | % reduction |
| | | droplet | droplet | of driftable | of driftable |
| | | fraction | fraction | droplet | droplet |
| | | (at % | (at % | fraction | fraction |
| | | vol <100 | vol <150 | (at % | (at % |
| | Concentration | microns) % | microns) % | vol <100 | vol <150 |
| Polymer | g/l | vol | vol | microns) | microns) |
| Water (reference) | — | 12.7 | 30.0 | — | — |
| Gum Arabic | 2 | 15 | 34 | −18.1 | −13.4 |
| Gum Arabic | 0.5 | 12.2 | 28.9 | 3.9 | 3.6 |
| Dextran | 2 | 13.8 | 32.3 | −8.7 | −7.8 |
| Dextran | 0.5 | 13.5 | 32 | −6.3 | −6.8 |
| k-Carrageenan | 2 | 8.9 | 23.6 | 29.9 | 21.3 |
| k-Carrageenan | 1 | 11.3 | 29 | 11.0 | 3.2 |
| k-Carrageenan | 0.5 | 11.1 | 28.2 | 12.6 | 5.9 |
| Polyox ® WSR 301 | 1 | 0.5 | 1.3 | 96.1 | 95.7 |
| (PEO 4 mio) | | | | | |
| Polyox ® WSR 301 | 0.25 | 1.9 | 6.1 | 85.0 | 79.6 |
| (PEO 4 mio) | | | | | |
| Polyox ® WSR | 1 | 1.4 | 4.7 | 89.0 | 84.3 |
| N12K (PEO 1 mio) | | | | | |
| Polyox ® WSR | 0.25 | 2.1 | 8.1 | 83.5 | 73.0 |
| N12K (PEO 1 mio) | | | | | |
| AgRho ® DR2000 | 0.5 | 7.00 | 19.2 | 44.9 | 35.9 |
| (HP Guar) | | | | | |
| AgRho ® DR2000 | 0.25 | 10.7 | 27 | 15.7 | 9.9 |
| (HP Guar) | | | | | |
| Rhodopol ® 23 | 1 | 8.6 | 23.7 | 32.3 | 20.9 |
| (xanthan) | | | | | |
| Rhodopol ® 23 | 0.25 | 11.9 | 28.3 | 6.3 | 5.6 |
| (xanthan) | | | | | |
| Natrosol ® 250 | 1 | 14.4 | 32.3 | −13.4 | −7.8 |
| HHX (HEC | | | | | |
| 1.3 mio) | | | | | |
| Tylose ® MH50 | 1 | 13.1 | 31.3 | −3.1 | −4.4 |
| (MHEC) | | | | | |

### Measurement by Method 2.

These results show that many high molecular weight (molar mass) polymers have little or no effect on reducing the driftable fraction of spray droplets. However, the effect of poly (ethylene oxide) (PEO) is clearly visible and shows the strongest effect here. The AgRho® DR2000 (HP guar) also stands out as being effective in reducing the driftable fraction of spray droplets. 5 For k-carrageenan and xanthan polymers a limited reduction in the driftable fraction of spray droplets is observed. However, the amount of polymer required in the formulation to achieve a significant reduction in the driftable fraction of spray droplets is very high with the result that with such an amount the tank mix formulation is too viscous to be poured from its bottle and readily dispersed in the spray liquid. 10

### Example Polymers2

TABLE P2.1
Spray droplet size for aqueous polymer solutions of PEO.

| | | | Amount of | Amount of | |
|---|---|---|---|---|---|
| | | | driftable | driftable | |
| | | | droplet | droplet | |
| | | | fraction | fraction | |
| | | | (at % | (at % | |
| | | Crovol | vol <100 | vol <150 | |
| | Concentration | CR70G | microns) | microns) | |
| Polymer | g/l | g/l | % vol | % vol | PCF |
| Water (reference) | — | — | 20.8 | 42.6 | — |
| Crovol CR70G 5 g/l | — | 5.0 | 19.6 | 48.1 | — |
| Polyox WSR 301 (4 mio) | 0.2 | 0.0 | 3.3 | 7.7 | 13.93 |
| Polyox WSR 301 (4 mio) | 0.1 | 0.0 | 4.8 | 11.8 | 6.96 |
| Polyox WSR 301 (4 mio) | 0.05 | 0.0 | 7.5 | 18 | 3.48 |
| Polyox WSR 301 (4 mio) | 0.025 | 0.0 | 12.6 | 26.7 | 1.74 |
| Polyox WSR 301 (4 mio) | 0.01 | 0.0 | 16.8 | 36.1 | 0.70 |
| Polyox WSR N60K (2 mio) | 0.4 | 0.0 | 3.7 | 9.4 | 10.56 |
| Polyox WSR N60K (2 mio) | 0.2 | 0.0 | 4.5 | 11.9 | 5.28 |
| Polyox WSR N60K (2 mio) | 0.1 | 0.0 | 8.7 | 20 | 2.64 |
| Polyox WSR N60K (2 mio) | 0.05 | 0.0 | 13.4 | 29.7 | 1.32 |
| Polyox WSR N60K (2 mio) | 0.02 | 0.0 | 16.5 | 35.8 | 0.53 |
| Polyox WSR N12K (1 mio) | 0.8 | 0.0 | 3.1 | 8 | 8.00 |
| Polyox WSR N12K (1 mio) | 0.4 | 0.0 | 5.5 | 15.1 | 4.00 |
| Polyox WSR N12K (1 mio) | 0.2 | 0.0 | 10.4 | 24.6 | 2.00 |
| Polyox WSR N12K (1 mio) | 0.1 | 0.0 | 16.1 | 35.1 | 1.00 |
| Polyox WSR N12K (1 mio) | 0.04 | 0.0 | 18 | 38.4 | 0.40 |
| Polyox WSR 301 (4 mio) | 0.2 | 5.0 | 3.3 | 8.4 | 13.93 |
| Polyox WSR 301 (4 mio) | 0.1 | 5.0 | 5 | 13.3 | 6.96 |
| Polyox WSR 301 (4 mio) | 0.05 | 5.0 | 6.3 | 16.1 | 3.48 |
| Polyox WSR 301 (4 mio) | 0.025 | 5.0 | 9.3 | 23.6 | 1.74 |
| Polyox WSR 301 (4 mio) | 0.01 | 5.0 | 13.3 | 33.1 | 0.70 |
| Polyox WSR N60K (2 mio) | 0.4 | 5.0 | 3.4 | 9.2 | 10.56 |
| Polyox WSR N60K (2 mio) | 0.2 | 5.0 | 4.7 | 13.1 | 5.28 |
| Polyox WSR N60K (2 mio) | 0.1 | 5.0 | 7.2 | 18.6 | 2.64 |
| Polyox WSR N60K (2 mio) | 0.05 | 5.0 | 11.1 | 27.9 | 1.32 |
| Polyox WSR N60K (2 mio) | 0.02 | 5.0 | 17.2 | 40.1 | 0.53 |
| Polyox WSR N12K (1 mio) | 0.8 | 5.0 | 3.1 | 9.1 | 8.00 |
| Polyox WSR N12K (1 mio) | 0.4 | 5.0 | 6.1 | 16.7 | 4.00 |
| Polyox WSR N12K (1 mio) | 0.2 | 5.0 | 9.6 | 24.9 | 2.00 |
| Polyox WSR N12K (1 mio) | 0.1 | 5.0 | 15.1 | 36.2 | 1.00 |
| Polyox WSR N12K (1 mio) | 0.04 | 5.0 | 17.3 | 41.8 | 0.40 |

Measurement by Method 2. Dose rate of the polymer for PCF calculation: 0.5 l/ha.

The results in Table P2.1 show that the molar mass (molecular weight) of the PEO Polyox polymer has a large effect on the driftable droplet fraction with the 4 million molar mass PEO having a much stronger effect than the 2 million molar mass PEO, which in turn has a stronger effect than the 1 million molar mass PEO. This is plotted in FIG. 4.

To account for this effect a Polymer Concentration Factor (PCF) for the PEO polymer content in the tank mix additives defined where C is the drift reducing polymer (a) concentration in the tank mix additive (g/1), M is the molar mass of the drift reducing polymer (a) (g/mol/1x10⁶), a has a value of 1.4 and D is the tank mix additive dose rate per ha (l/ha). The PCF value is calculated from the following equation:

$$P C F = C \times {M}^{a} \times D$$

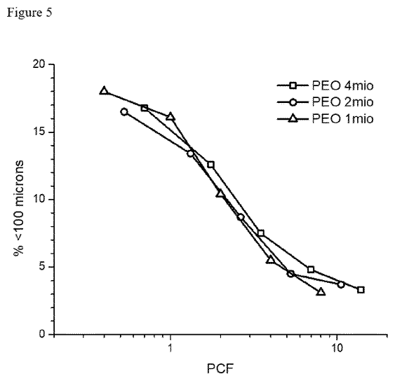

PCF values of recipes used in the examples are listed in Table P2.2 and span a range of approximately 1 to 14. The correlation between PCF value and driftable fraction of spray droplets is plotted in FIG. 5 and shows that higher PCF values correspond to lower fractions of driftable spray droplets. These results demonstrate that the preferred range of PCF values is from about 2 to about 10. Below about 2 and above about 10 it was shown that the PCF factor has less effect on the %<100 microns value (FIG. 5). Furthermore, PCF values allow for the polymer content of other molar mass grades of PEO for example down to 0.5 million g/mol and up to 10 million g/mol, and also intermediate molar mass grades such as 1.5 million and 3 million g/mol.

TABLE P2.2
PCF values for recipe examples

| | | Concentration | Polymer molar mass | Dose |
|---|---|---|---|---|
| Recipe examples | PCF | g/L | g/mol/1 × 10⁶ | l/ha |
| 2, 4 | 4.0 | 8 | 1 | 0.5 |
| 5 | 6.0 | 12 | 1 | 0.5 |
| 6 | 1.0 | 2 | 1 | 0.5 |
| 8, 10 | 7.7 | 2.2 | 4 | 0.5 |
| 11 | 13.9 | 4 | 4 | 0.5 |
| 12 | 3.5 | 1 | 4 | 0.5 |
| 14, 16 | 5.8 | 4.4 | 2 | 0.5 |

1. A tank mix additive for an agrochemical formulation comprising
a) one or more polymer-based drift reducing additive selected from poly (ethylene oxide) (PEQ) and hydroxypropylated guar.
b) one or more oil-based drift reducing additive,
c) one or more spreading agents or uptake promoting additives,
d) other formulants,
e) one or more carriers to volume, wherein at least one carrier is water,
characterized in that
a) is present in 0.2-50 g/l,
b) is present in 0.5-45 g/l,
c) is present in 10-200 g/l,
d) is present in 20-300 g/l.

2. A tank mix additive Tank mix additive for an agrochemical formulation according to claim 1, wherein
a) is present in 1-15 g/l,
b) is present in 5-25 g/l,
c) is present in 25-140 g/l,
d) is present in 30-135 g/l,
e) carrier to volume.

3. A tank mix additive for an agrochemical formulation according to claim 1, wherein a) is poly (ethylene oxide) with an average molecular weight from 0.5 to 14 million g/mol.

4. A tank mix additive for an agrochemical formulation according to claim 3, wherein the formulation has a Polymer Concentration Factor (PCF) between 1 and 10.

5. A tank mix additive according to claim 4, wherein the Polymer Concentration Factor (PCF) for the poly (ethylene oxide) (PEO) content in the tank mix additive is calculated from the following equation:
$$P C F = C \times {M}^{a} \times D$$
where C is the drift reducing polymer (a) concentration in the tank mix additive (g/1), M is the molar mass of the drift reducing polymer (a) (g/mol/1×10⁶), α has a value of 1.4 and D is the tank mix additive dose rate per ha (l/ha).

6. A tank mix additive for an agrochemical formulation according to claim 1, wherein b) is selected from vegetable oils, vegetable oil esters, and vegetable oil diesters.

7. A tank mix additive for an agrochemical formulation according to claim 1, wherein the spreading agent c) is selected from sodium dioctylsulfosuccinate, polyalkyleneoxide modified heptamethyltrisiloxanes, ethoxylated diacetylene-diols with 1 to 6 ethylene oxide units or ethoxylated alcohols or propoxy-ethoxylated alcohols with 6-22 carbon atoms and an average of 5-40 ethylene oxide or propylene oxide units.

8. A tank mix additive for an agrochemical formulation according to claim 1, wherein the uptake promoting additive c) is selected from alcohol alkoxylates comprising 6-22 carbon atoms, ethoxylated carboxylic acids or propoxy-ethoxylated carboxylic acids comprising 6-22 carbon atoms, ethoxylated mono-, di- or triesters of glycerine comprising fatty acids with 8-18 carbon atoms and an average of 5-60 ethylene oxide units, alkoxylated sorbitan fatty acid esters comprising fatty acids with 8-18 carbon atoms and an average of 10-50 ethylene oxide and propylene oxide units, ethoxylated coconut alcohols comprising 2-20 ethylene oxide units or castor oil ethoxylates comprising an average of 5-40 ethylene oxide units.

9. A tank mix additive for an agrochemical formulation according to claim 1, wherein the other formulants d) are one or more substances selected from rain-fast additives, surfactants, rheological modifiers, antifoam substances, antifreeze agents, preservatives, biocides, colourants, pH adjusters, buffers, stabilisers, antioxidants, inert filling materials, humectants, crystal growth inhibitors or micronutirients.

10. A tank mix additive for an agrochemical formulation according to claim 1, wherein the ratio in the tank mix additive of a) to b) is from 1:40 to 10:1.

11. A tank mix additive for an agrochemical formulation according to claim 1, wherein the ratio in the tank mix additive of a) to b) to c) is from 1:40: 150 to 10:1: 10.

12. A method of applying an agrochemical tank mix additive according to claim 1 onto crops, wherein the tank mix additive is applied at a spray volume of between 1 l/ha to 2000 l/ha.

13. A method of applying an agrochemical tank mix additive composition according to claim 1 onto crops, wherein the tank mix additive is applied at a spray volume of between 1 and 25 l/ha.

14. The use of a tank mix additive claim 1 to deliver to the agricultural target plot in
an amount of a) between 0.5 and 15 g/ha, and
an amount of b) between 0.5 and 40 g/ha, and
an amount of c) between 10 and 200 g/ha.

15. The use of a tank mix additive according to claim 1 in application of agrochemical compounds for controlling harmful organisms, wherein a formulation or spray liquid containing the tank mix additive is applied by an unmanned aerial vehicle UAV or an unmanned guided vehicle UGV or a spray nozzle device using pulse width modulation PWM.
